(19) United States
(12) Patent Application Publication
(10) Pub. No.: US 2009/0295787 A1
(43) Pub. Date: Dec. 3, 2009

(54) Methods for Displaying Objects of Interest on a Digital Display Device

(75) Inventors: Ting Yao, San Jose, CA (US); Jiping Zhu, San Jose, CA (US); Xuyun Chen, San Jose, CA (US); Michael Yip, Los Altos, CA (US)

Correspondence Address: Venture Pacific Law, PC, 5201 Great America Parkway, Suite 270, Santa Clara, CA, 95054, US

(73) Assignee: Amlogic, Inc., Santa Clara, CA (US)

(21) Appl. No.: 12/131,908

(22) Filed: Jun. 2, 2008

(51) Int. Cl. G06F 17/00

(52) U.S. Cl. 345/418

(57) ABSTRACT

The present invention relates to methods for dynamically displaying an image on a display window of a digital display device, such as a digital picture frame. These methods may include the following steps: identifying one or more objects of interest in a source image; defining a crop area as a function of the one or more objects of interest; decoding the crop area of the source image into a canvas image; and displaying the selected area of the canvas image.

### FIELD OF INVENTION

This invention relates to methods for displaying a digital image on a digital display device, such as a digital picture frame, and, in particular to, methods for dynamically identifying and displaying objects of interest in an image on a digital display device.

### BACKGROUND

Digital display devices (“DDDs”) such as digital picture frames (“DPFs”) provide for the display of a collection of photos, images or even videos. The advancement in the mass production of LCD's resulted in the lowering of the cost of the LCD's and therefore the DDDs. As DDDs become more and more popular, the particular problems associated with DDDs are becoming apparent and require customized solution. There are several factors to consider with respect to DDDs, for example image quality, ease of setup, ease of use, and image presentation.

Ideally, DDDs should be able to accept a source image from a variety of capture devices or external media. The source image may have a variety of properties such as having a variety of heights, widths, aspect ratios, resolutions, and metadata. At present, most DDDs only provide for the limited processing of the source image. They may be able to reduce the resolution of the source image to conform to the resolution of the DDD or crop the source image such that only a portion of the source image is displayed. For example, if the provided source image has a size of 1024×768 pixels and the particular DDD has a display window size of 720×480 pixels, the provided source image needs to be resized or cropped before it can be properly displayed on the display window of the DDD.

However, these types of resizing methods do not allow the DDDs to display the source image adequately. DDDs generally do not provide tools to allow the end user to automatically process the image so that the objects of interest are displayed in a central position on the display window of the DDDs. For instance, FIG. 1 illustrates a source image of a man, woman, child, and dog, with trees and clouds in the background. The face of the man (102), the face of the woman (104), the face of the child (106), and the dog (108), the objects of interest, are off center and located in the top-left quadrant of the image. FIG. 2 illustrates the displayed image of FIG. 1 on a DDD by using the prior art method of transferring the entire image to the display window without editing. Again, the faces and the dog are off center and a large blank area is exposed at the bottom right quadrant of the illustration.

Other prior art methods, a result of which is illustrated in FIG. 3, simply crop the outer edges of the image for display in order to resize the image to fit the display window of the DDD. The prior art methods disregarded the properties of the source image when resizing or cropping the source image. This becomes problematic as evidenced in FIG. 3 where the faces of the people are not displayed on the DDD since the faces are located on one side of the image.

Therefore, it is desirable to provide methods for displaying images on the display window of a DDD that would take into account the properties of the image.

### SUMMARY OF INVENTION

An object of this invention is to provide methods for automatically adjusting the mode of display of an image as a function of the properties of the image.

Another object of this invention is to provide methods for automatically identifying the objects of interest in an image.

Another object of this invention is to provide methods to crop an image as a function of the location of the objects of interest in the image.

Another object of this invention is to provide methods for automatically applying predefined effects to an image.

The present invention relates to methods for dynamically displaying an image on a digital display device, such as a digital picture frame. These methods may include the following steps of: identifying one or more objects of interest in the image; defining a crop area as a function of the one or more objects of interest; decoding the crop image into a canvas; and displaying the selected area of the canvas.

An advantage of this invention is that the mode for display of an image can be automatically adjusted as a function of the properties of the image.

Another advantage of this invention is that an image can be automatically cropped as a function of the locations of the objects of interest in the image.

Yet another advantage of this invention is that one or more of the predefined effects may be automatically applied to the objects of interest for display on a digital display device.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a source image.

FIG. 2 is an illustration of a display window of a DDD using prior art methods for displaying the source image of FIG. 1.

FIG. 3 is an illustration of a display window of a DDD using prior art methods for displaying the image of FIG. 1.

FIG. 4 is an illustration of the image being processed to find objects of interests. Here, the faces and the dog are identified as objects of interest.

FIG. 5 is an illustration of a selected crop area as a function of the objects of interest of the source image. Here, the objects of interest are the man, woman, child, and dog.

FIG. 6 is an illustration of a display window of a DDD displaying the crop image of FIG. 5.

FIGS. 7a-7f illustrate the images displayed by the viewing windows at different time periods using the methods of panning and zooming over the canvas image.

FIGS. 8a-8f illustrate the corresponding display windows of the images from FIGS. 7a-7f.

FIGS. 9a-9c illustrate the predefined effect of switching the objects of interest with other objects of interest within the same source image. Here, the man's face is switched with the woman's face.

FIGS. 10a-10b illustrate the process flow of a presently preferred embodiment of this invention.

FIGS. 11a-11b illustrate several paths through a canvas image.

### DETAILED DESCRIPTION OF THE PREFERRED EMBODIMENTS

The presently preferred embodiments of the present invention provide methods for dynamically displaying a source image as a function of the properties of the source image for display on a digital display device. An image referred to herein may be any digital image, including but not limited to a source image, a crop image, a canvas image, and a viewing image. The source image may be obtained from a capturing device, such as a digital camera, or a storage device, such as a hard drive, USB drive, secured digital card, or flash card.

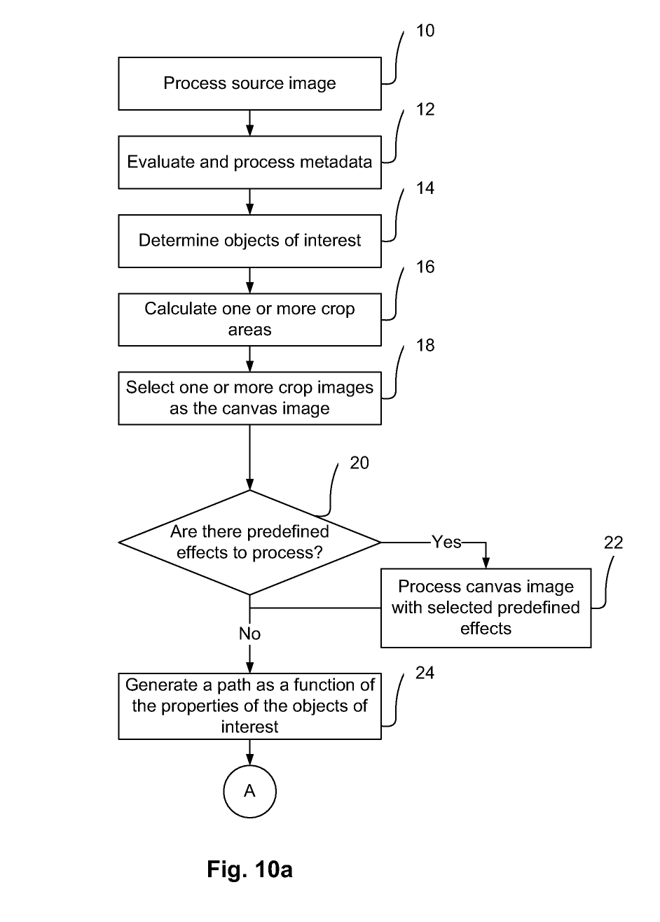

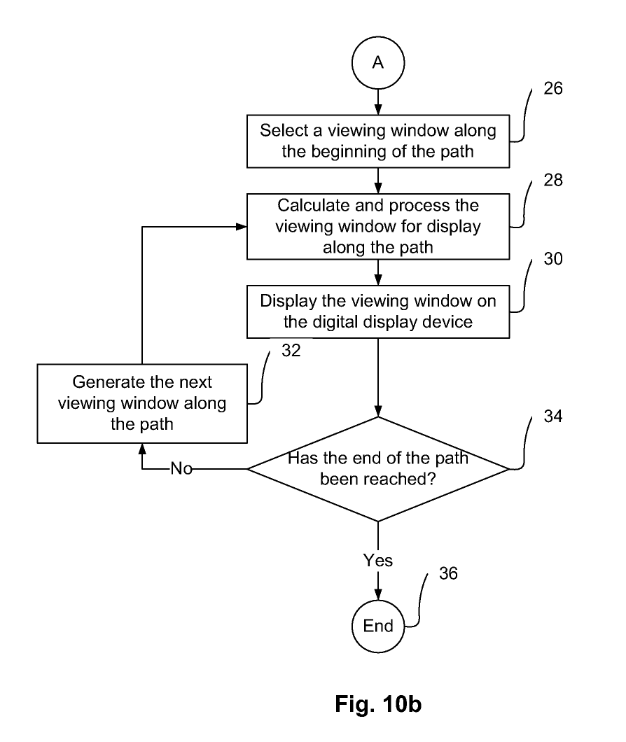

The processing of the source image (FIG. 10a, 10) for display on a DDD may include one or more of the following steps: obtaining or downloading the source image from a capture device or a storage device; obtaining the properties of the source image, such as its width, height, aspect ratio (width/height), image ratio (height/width), or metadata; and decoding, if necessary, the source image into the internal format of the DDD, or from the high resolution source image to a lower resolution image to reduce the storage size.

The processed source image may be evaluated to determine whether predefined metadata exists (FIG. 10a, 12). Metadata is data about another piece of data. Here, it means data about the source image. Many image file formats support metadata, such as the Joint Photographic Experts Group (“JPEG”) using Exchangeable Image File Format (“EXIF”) and the Tagged Image File Format (“TIFF”). Depending on the image file format, there may be hundreds of metadata about the source image including the properties of the source image such as its creation date, height, width, resolution, focal point(s), facial recognition (if any), and the setting information of the capture device such as the lens, focal length, aperture, shutter timing, and white balance.

Predefined metadata may include information used by the methods of this invention such as facial recognition information, cropping information, one or more locations of the objects of interest, and other image properties such as resolution, aspect ratio, width and height. If predefined metadata does exist, the predefined metadata is stored for further processing.

The next process is to identify one or more objects of interest (FIG. 10a, 14). The objects of interest may be objects displayed in a source image that may have added significance, where that significance may be defined by the DDD user or may be predefined by the methods of this invention. The predefined objects of interest may include a person's face, a pet, a building, a flower, and an automobile. Objects may be defined to be anything displayed in the image.

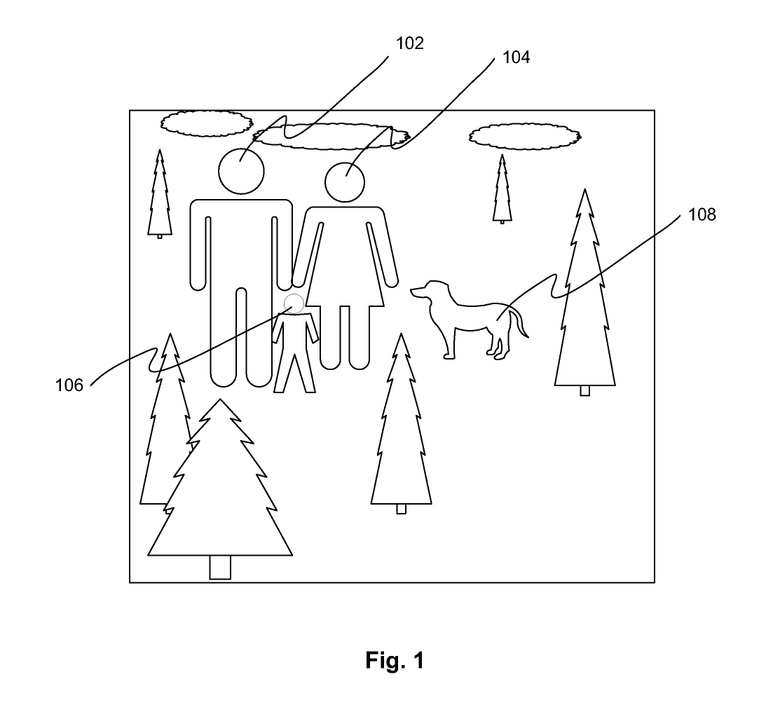

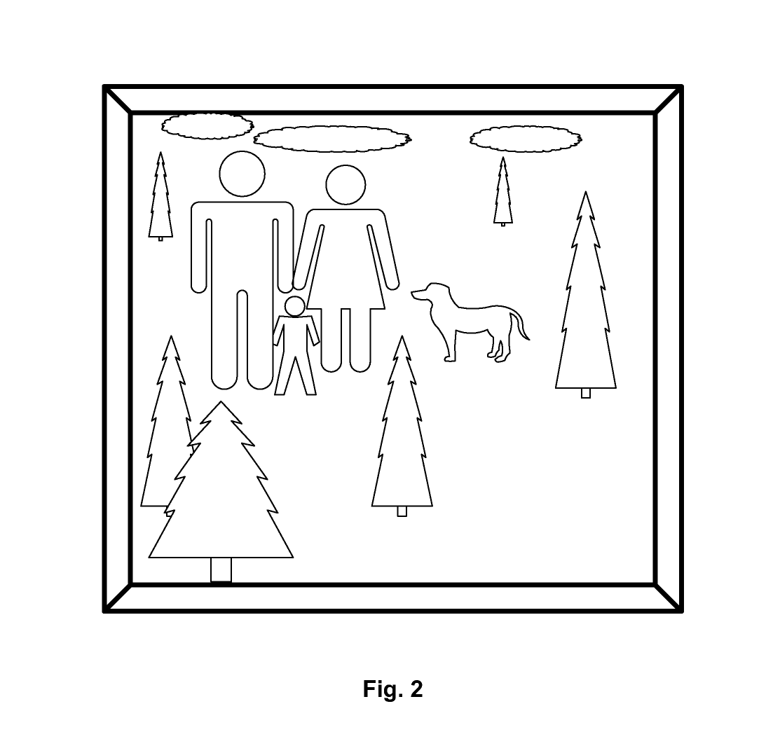

The objects of interest may be prioritized based on the type of the objects of interest and other properties of the objects of interest. There may also be sub-priorities within each type of objects of interest based on the properties of the objects of interest. The priorities may be used later on to process the source image for dynamic display. For instance in FIG. 1, the methods of this invention have identified four objects of interest (102-108). The four objects may be grouped into two priority types, the first being people's faces and the second being pets. Here, the people's faces (102-106) are determined to be of higher priority than the dog (108). If a path is later generated (FIG. 10a, 24), then the prioritization information may be used to determine the duration of time to display each person's face (102-106) and the duration of time to display the dog (108). For instance, the duration of time in displaying each person's face (102-106) may be twice as long as the duration of time in displaying the dog (108) since each person's face (102-106) has higher priority than that of pets.

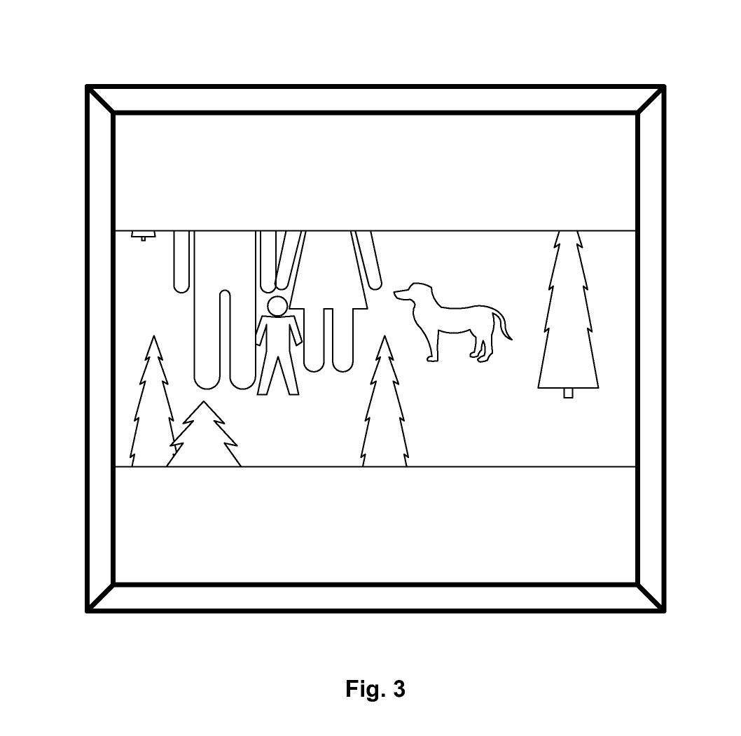

Furthermore, the same type of objects of interest may be prioritized amongst each other. For instance in FIG. 4, the methods of this invention may prioritize each face within the type of people's faces. Priority may be based on several factors including, but not limited to, the distance of the objects of interest to the capturing device, the color of the objects of interest, the width, the height, the orientation, and the size of the objects of interest, the relative distances of the same type of objects of interest, the relative distances of the other types of objects of interest, and other relevant factors. The orientation of an object may mean the position or alignment of that object relative to the image boundaries, relative to other objects within that image, relative to the display window of a DDD for displaying that image, and/or relative to other reference points. Again, the priority information of the objects of interest may be used by the methods of this invention for further processing of the image for dynamic display. For example, in FIG. 1, the size of the head of the man and woman are larger than the size of the head of the child; it can be determined that the man and woman should have higher priorities than the child. Common photograph styles can be used as well to assist in the determination of the objects of interest or the priorities of such objects of interest. For example, it is common to have people lined up for photographs with, typically, the important people (for the occasion) lined up front and center.

Once the objects of interest are identified and prioritized, the methods of this invention may define a crop area by calculating an optimal area to crop as a function of the properties of the image (FIG. 10a, 16). Note that one or more crop areas may be defined to have one or more crop images that will be used for display on the DDD. The resulting image will be referred to as the crop image.

The crop area may depend on whether the area is overexposed or underexposed, the location, size, orientation, and priority of each object of interest, or the aspect ratio of the display device, as well as other factors. The DDD user may set the DDD to crop areas automatically based on the above factors or define the DDD user's own cropping criteria.

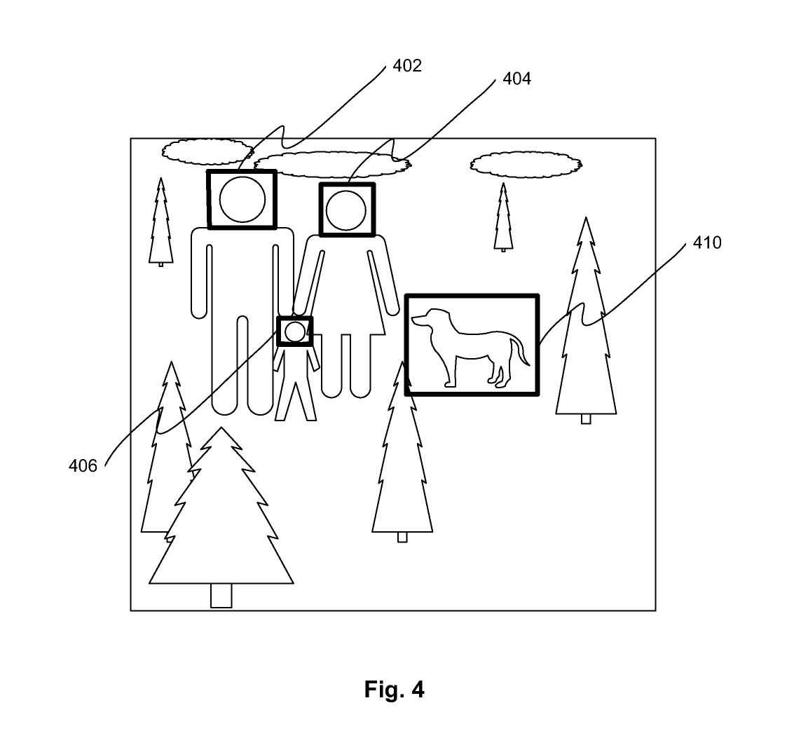

Once the crop area has been identified, then the source image can be further processed by cropping away the one or more calculated crop areas, and the image can then be decoded into a buffer for further processing. For instance, FIG. 5 illustrates an image where the methods of this invention have calculated the crop area and identified the crop image (502). FIG. 6 illustrates the displaying of the crop image onto a DDD. The crop image is also referred to as the canvas image (FIG. 10a, 18).

Next, whether the selected canvas image meets one or more of the conditions for applying one or more of the predefined effects (FIG. 10a, 20) is determined. Predefined effects may be photographic effects applied to an image, such as, but not limited to, switching the location of one object of interest with the location of another object of interest, stretching or skewing the one or more objects of interest, and finding the minimal viewing window to display one or more of the objects of interest on a display window of a DDD.

Whether to apply one or more of the predefined effects may be defined either by the DDD user or selected by methods of this invention. The DDD user may chose to apply one or more of the predefined effects on the image by inputting their choice(s) into the DDD. The methods of this invention may also provide a random selection tool that randomly picks one or more of the predefined effects. Alternatively, the methods of this invention may apply one or more of the predefined effects based on the number of objects of interest, the relative locations of the objects of interest, the priority of each object of interest, the orientation of each object of interest, the properties of the canvas image, and the properties of the display window.

If the canvas image meets one or more of the conditions for applying predefined effects, the canvas image is processed and an image is generated with one or more of the selected predefined effects (FIG. 10a, 22). The one or more selected predefined effects may include: switching the location of an object of interest with another object of interest; switching the location of a portion of an object of interest with the location of another object of interest; switching the location of a portion of an object of interest with the location of a portion of another object of interest; stretching and skewing an object of interest or a portion of an object of interest; and replacing the background of an object of interest. The possible number of predefined effects are limitless since that number is dependent on the number of possible photographic effects, which itself is limitless.

For the methods of this invention that switch the location of one object of interest with the location of another object of interest, several factors may be taken into consideration. For use herein, the object of interest to be placed in a specified location of another object of interest will be referred to as the switching object of interest, and the object of interest to be replaced will be the switched object of interest.

The first factor which may be taken into account is the difference in the relative sizes of the objects of interest; since switching the location of the objects of interest with different sizes may lead to distortion with the associated background. The associated background may be defined as one or more objects adjacent to the objects of interest in the image. For instance in FIG. 1, if the child's face (106) is switched with the man's face (102) without resizing of the faces, then the respective bodies, the associated background, would look disproportionate to the faces. In order to fix this problem, the presently preferred embodiment may resize the faces or any other objects of interest to proportionally fit the location of the switched object of interest.

The presently preferred embodiment may circumscribe the object of interest with a locator box, where the borders of the locator box are at predefined distances from the object of interest. The resizing of the object of interest may be done by stretching or skewing the switching object of interest to fit the locator box of the switched object. For instance in FIG. 4, the child's face may be stretched to fit in the locator box of the man's face (402) and the man's face may be shrunk to fit in the locator box of the child's face (406).

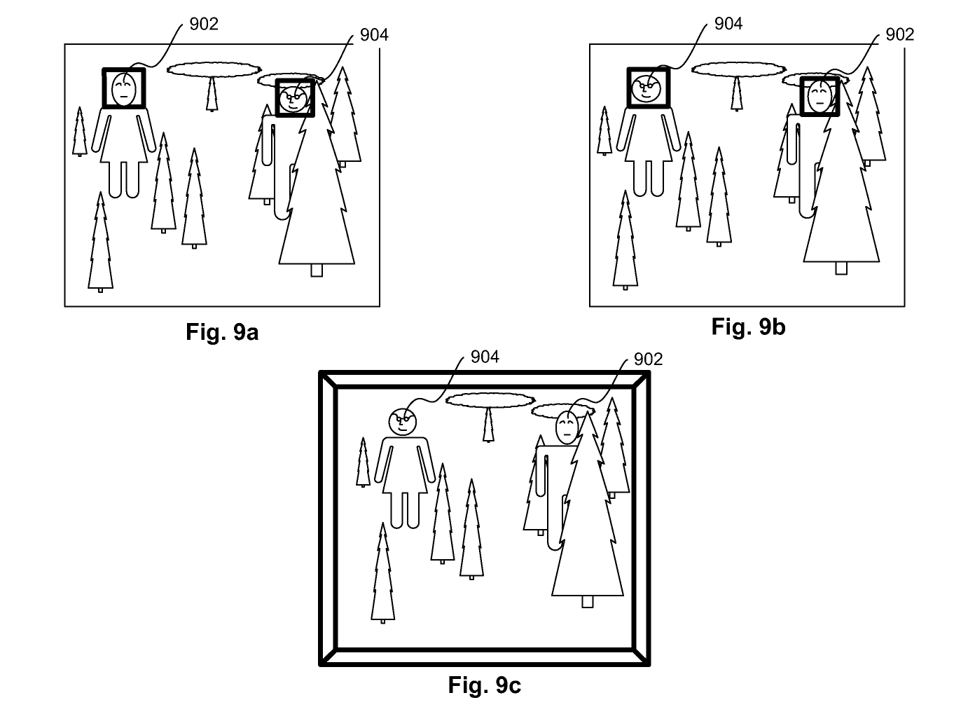

The second factor when switching the location of the objects of interest is that background pixels of a locator box may need to be generated at certain pixel locations, herein defined as “blank pixels,” where the switching object of interest does not cover the pixels of where the switched object of interest once resided. For instance FIGS. 9a through 9c illustrate this problem of blank pixels where the two objects of interest, the woman's face (902) and the man's face (904) are to be switched with each other. The woman's face (902) will not cover all the points covered by the man's face (904) since the man's face (904) is wider than the woman's face (902). In order to overcome this, the methods of this invention may extrapolate what colors may be placed in the points not covered. The extrapolation step may be a function of the size of the switching object of interest, the size of the switched object of interest, and the surrounding colors around the switched object of interest. FIG. 9c illustrates the display window of the image after applying the predefined effect of switching. The extrapolation step may fill in any blank pixels with similar colors to the background objects that are adjacent to the blank pixels.

Similarly, the extrapolation step may be done for other predefined effects where an object of interest is switched or replaced. For instance, the predefined effect where the object of interest is replaced by a predefined object, such as replacing a face located in the image with a cartoon character's face found in a different image. The extrapolation step may be necessary to fill in blank pixels where the cartoon character's face may not cover the pixels of the object of interest. This is one example of many where the extrapolation step may be used.

If one or more of the conditions for applying one or more of the predefined effects have been completed, next, a path may be generated based on the properties of the objects of interest (FIG. 10a, 24). A path referred to herein may be understood as a path in a canvas image for which successive viewing windows are provided along the path for display on a digital display device. A path may either be predefined by the DDD user or may be automatically generated by the methods of this invention. A path may be generated as a function of the properties of the objects of interest, the properties of the source image, the crop area, the properties of the canvas image, the properties of the viewing window, the properties of the display window of the DDD, and other factors as well.

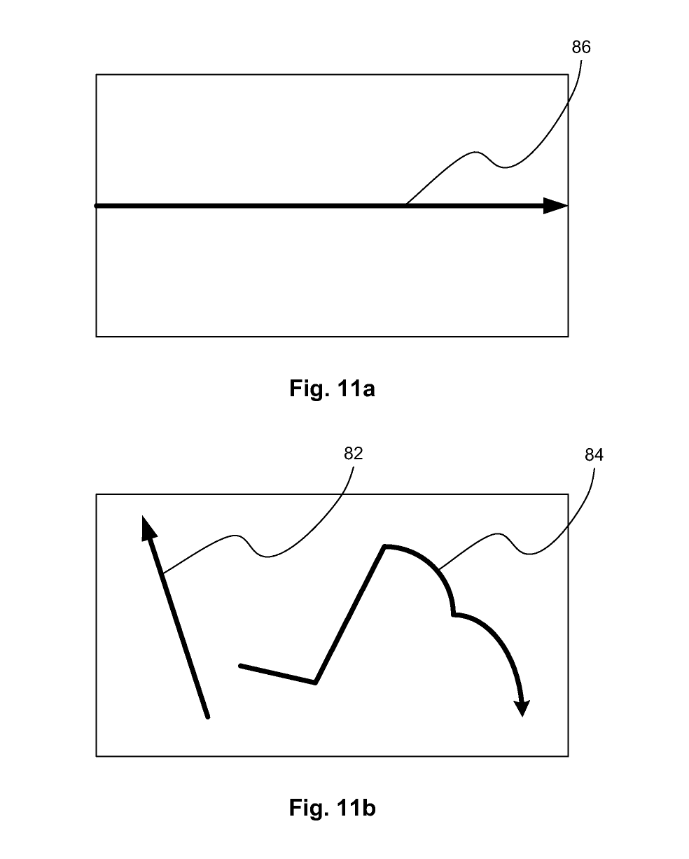

A simple example of a path in a canvas image may be a path from the left-edge of a canvas image to the right-edge of the canvas image, wherein the path may be centered along the height of the canvas image (see FIG. 11a, 86). A viewing window of a predefined size may trace this path for display on a display window of a DDD.

A path may also start from any point on a canvas image, and may or may not be continuous or periodic. For instance in FIG. 11b, a path is generated starting at the bottom-left side of a canvas image and ascends to the top-left side of the canvas image (82), then continues at another point on the bottom-left side of the canvas image following a random pattern until the path descends to the bottom-right side of the canvas image (84).

Once a path has been defined, the methods of this invention may provide for panning and zooming along the path as a function of the path, one or more of the properties of the source image and/or canvas image, including the properties of the objects of interest such as orientation, type, and priority, the crop area, the canvas image properties such as height, width, and aspect ratio, and the viewing window properties such as height, width, and aspect ratio, and the display window properties such as height width, and aspect ratio. Panning and zooming along a defined path may include many variations. The following examples below illustrate a few of the infinite number of different permutations for panning and zooming over a defined path

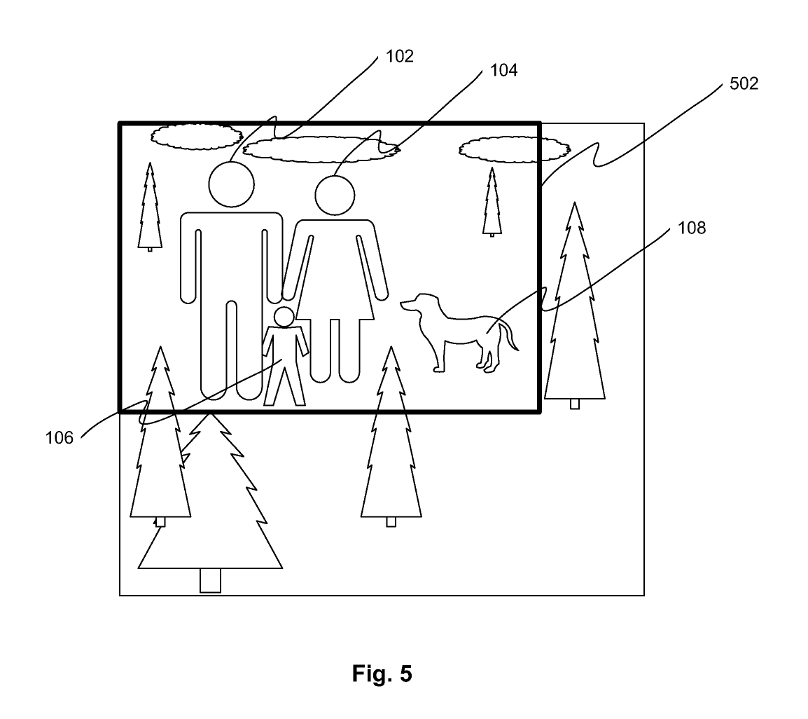

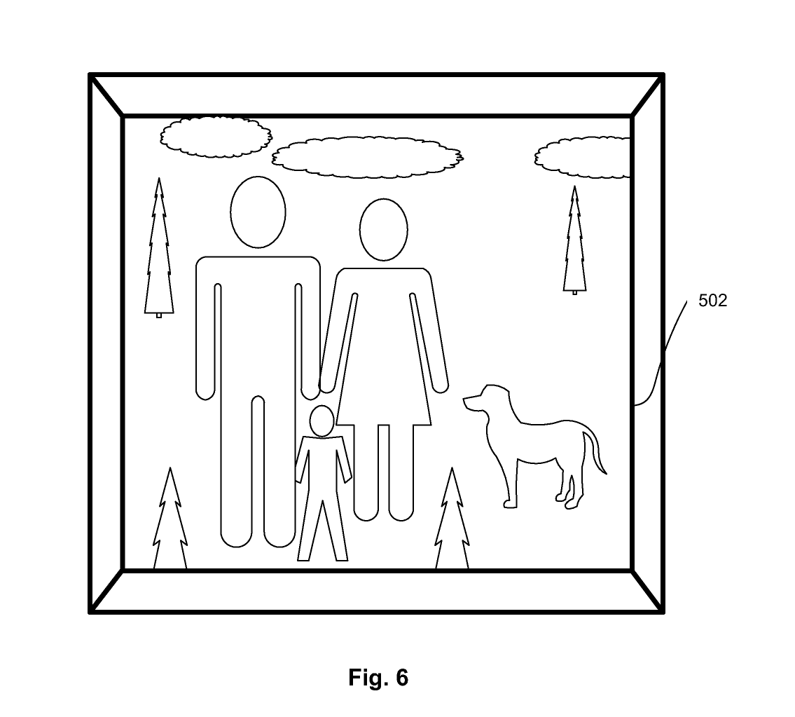

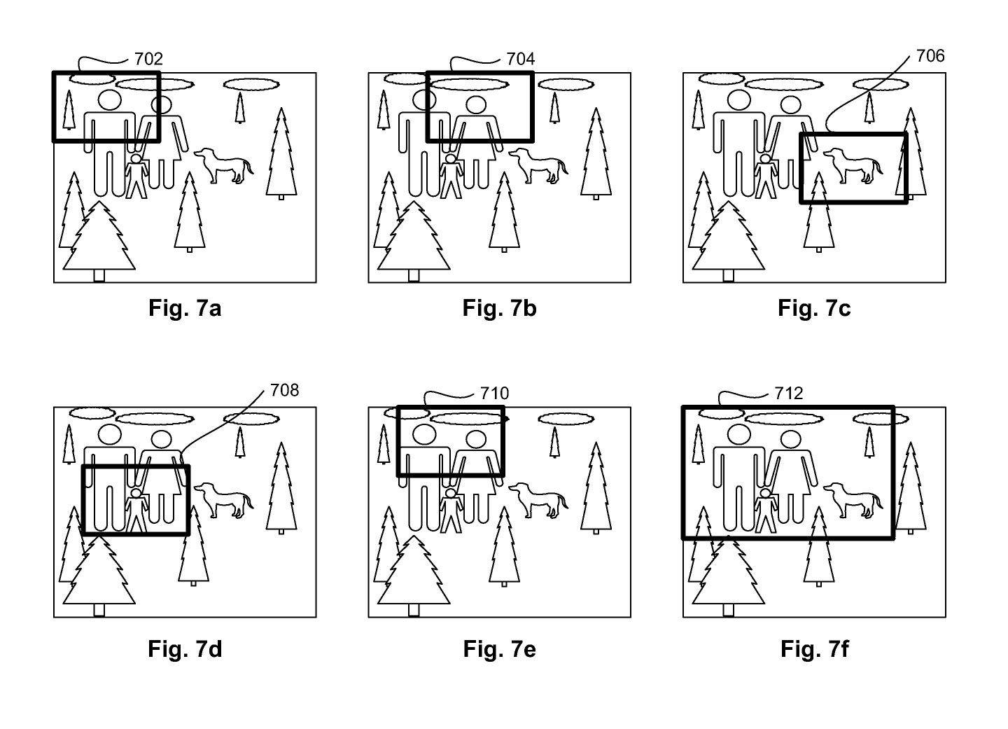

An example of panning and zooming along a path is given in FIGS. 7a-7f. The initial viewing window (702) displays a portion of the canvas image, starting at one object of interest. The successive viewing windows, not shown, follow the path from one object of interest to another object of interest. During the trace through the path, the viewing window is successively displayed on the display window of the DDD. The successive viewing windows (704-712) of FIGS. 7b-7f illustrate different points in time at which the viewing window is displayed. Here, panning is conducted by tracing the viewing window along the defined path from one object of interest to another object of interest, then zooming out to view all the objects of interest.

Panning and zooming may also trace along a path in a nonlinear fashion such that the viewing window may jump from one point on the path to another point on that path without tracing through the points along that path that are between those two points. For instance in FIGS. 7a-7f, the viewing window (702) containing the man may be initially displayed, then the display may jump to another viewing window (708), containing the child, without displaying other viewing windows in between. The display may end by jumping to a final viewing window (712), once again, without displaying other viewing windows along the path.

Panning and zooming may also be performed in a variety of ways such as by panning from right to left with no zooming in and out of the one or more objects of interest, by panning from the left most object of interest to the right most object of interest or vice versa, by panning, zooming in and out, and/or focusing on each object of interest. Particularly in FIGS. 7a-7f, where the four objects of interest have been identified, the generated path is a circular motion starting from the man, viewing window (702), to the woman, viewing window (704), to the dog, viewing window (708), and back to the child, viewing window (708), then zooming out to encompass all the objects of interest, viewing window (712). As described above, the number of permutations for panning and zooming along a path is endless.

Note that panning and zooming may be mutually exclusive, such that only panning may be applied to the image during display, or alternatively, only zooming in and out of focal points may be applied to the image during display.

Additionally, the methods of this invention for panning and zooming may display one or more specific viewing windows for a longer or a shorter duration of time than other viewing windows along a defined path. The duration of time to display a viewing window may be dependent on the defined path, one or more of the properties of the source image and/or canvas image, including the properties of the objects of interest such as its type and priority, the crop area, the canvas image properties such as height, width, and aspect ratio, and the viewing window properties such as height, width, and aspect ratio, and the display window properties such as height width, and aspect ratio. For instance in the example of panning and zooming along a path given in FIGS. 7a-7f, viewing window (702), which contains the image of the man's face, may be displayed for a longer duration of time than the display of viewing window (706), which contains the image of the dog, since between the two objects of interest, the man's face and the dog, the man's face may have higher priority than the dog. Thus, it may be preferable to display viewing window (702) that contains the image of the man's face for a longer duration of time.

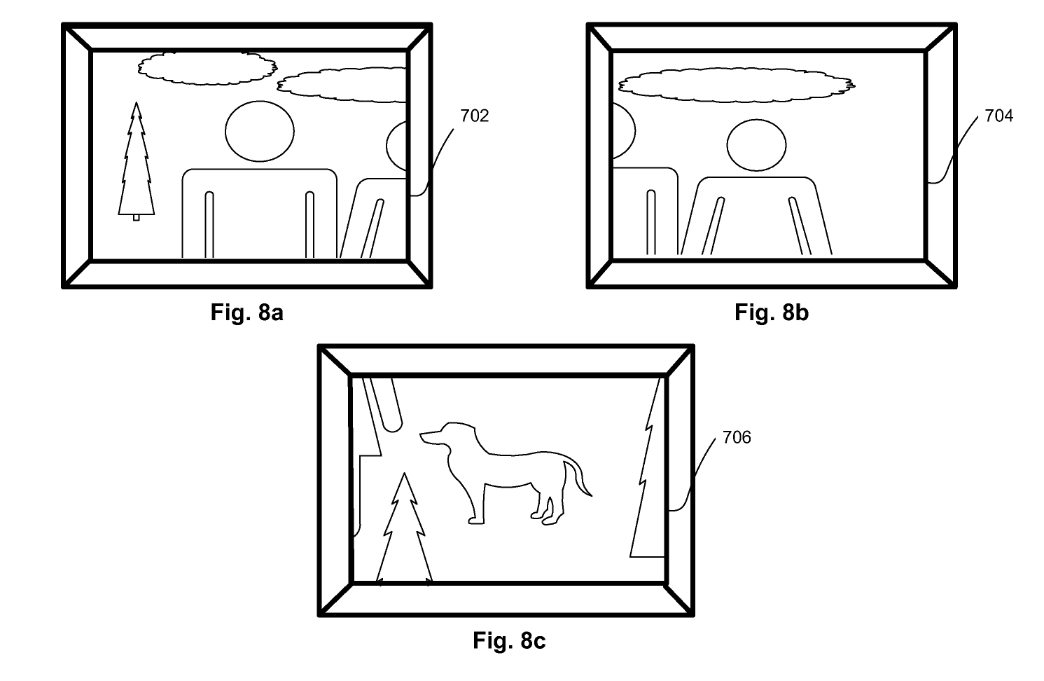

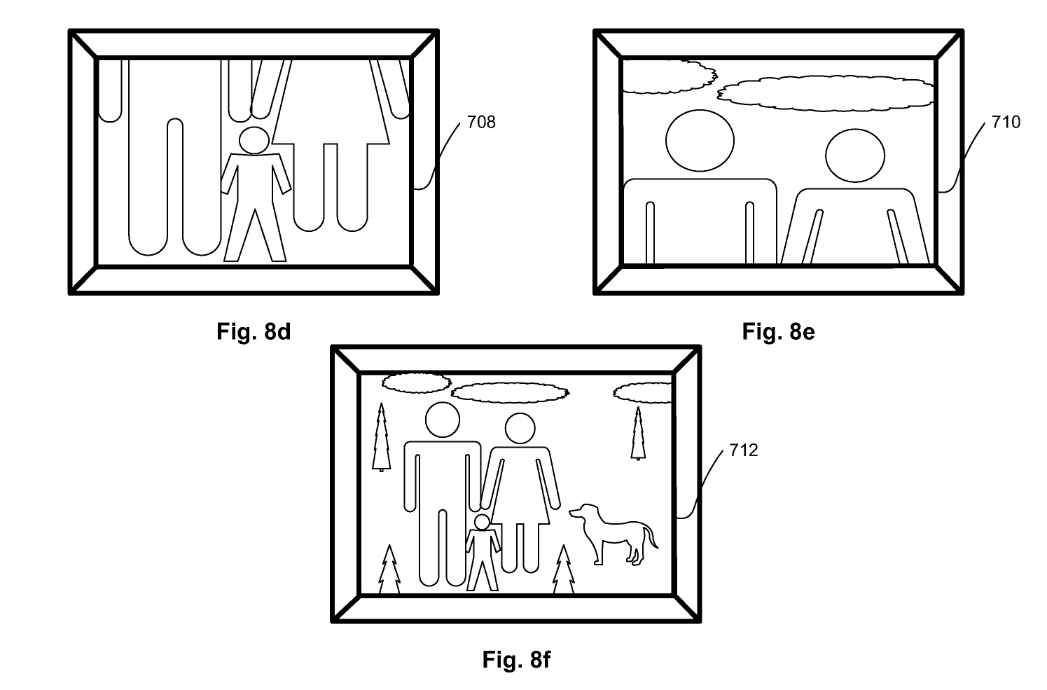

Once the initial viewing window is processed and displayed on the display window of the DDD, the successive viewing windows are processed and displayed on the display window in continuous order until the end of the path has been reached. FIGS. 8a-8f illustrate the display window at various points in time as the viewing window is panning and zooming over the image as illustrated in FIGS. 7a-7f.

Note that in the processing and the displaying step, this may include rotating the image of the viewing window for display on the DDD as a function of the properties of the objects of interest, the crop area, the one or more predefined effects, and the panning and zooming. For instance in FIG. 7a, the image of the viewing window (702) can be rotated for display, such that the image may be displayed 180 degrees (upside down) or at any other angle relative to the non-rotated display of the image of the viewing window (702). This is extremely useful for rotating an image such that the objects in the image can be displayed with the same orientation as the original objects when the image was taken.

However, if the DDD user decides to deactivate the panning and zooming, then the image can be statically displayed. For static display, the viewing window is proportioned directly to the size of the canvas image since the whole canvas is to be displayed (FIG. 10b, 28). The viewing window is then resized to fit the display window of the DDD. Once the viewing window has been resized, display the viewing window in the display window of the DDD (FIG. 10b, 30). The image of the viewing window may also be rotated for display on the DDD.

After the viewing window has been displayed, then the present embodiment determines whether the end of the path has been reached (FIG. 10b, 34). If not, then the next viewing window is calculated, processed, and displayed as previously described (FIG. 10b, 32). If the end of the path has been reached, then the present embodiment is done displaying the source image (FIG. 10b, 36).

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for displaying an image in a digital display device, comprising the steps of:
identifying one or more objects of interest in a source image;
defining a crop area as a function of the one or more objects of interest;
decoding the crop area into a canvas image; and
displaying one or more selected areas of the canvas image on a digital display device.

2. The method of claim 1 further including a step after the decoding step: applying one or more predefined effects on the canvas image.

3. The method of claim 1 wherein in the defining step, the crop area is also defined as a function of the aspect ratio of the display device.

4. The method of claim 3 wherein in the defining step, the crop area is also defined as a function of the locations, sizes, and priorities of the objects of interest.

5. The method of claim 1 wherein in the defining step, the crop area is also defined as a function of the locations, the sizes, and the priorities of the objects of interest.

6. The method of claim 1 wherein in the displaying step, a path for displaying one or more selected areas of the canvas image is defined.

7. The method of claim 6 wherein the path is defined as a function of the properties of the objects of interest.

8. The method of claim 7 wherein in the displaying step, panning and zooming along the path.

9. The method of claim 1 wherein one of the objects of interest is switched to a switched object of interest.

10. The method of claim 1 wherein one or more of the objects of interest is a human face.

11. The method of claim 1 wherein the objects of interests are assigned priorities as a function of the properties of the one or more objects of interest, including the type of object of interest, the relative distances between the objects of interest, the distance between the objects of interest and the crop area, the color of the objects of interest, and the relative sizes of the objects of interest.

12. The method of claim 1 wherein a portion of one of the objects of interest is switched to a pre-defined image.

13. The method of claim 1 wherein in the displaying step, panning and zooming along the path.

14. The method of claim 13 wherein the panning and zooming is performed as a function of the properties of the objects of interest and the path.

15. A method for displaying an image in a digital display device, comprising the steps of:
identifying one or more objects of interest in a source image, wherein each object of interest has one or more properties;
defining a crop area as a function of the one or more objects of interest, wherein the crop area is defined as a function of the properties of the objects of interest;
decoding the crop area into a canvas image;
defining a path for displaying one or more selected areas of the canvas image; and
displaying one or more selected areas of the canvas image.

16. The method of claim 15 wherein the path is defined as a function of the properties of the objects of interest.

17. The method of claim 16 wherein in the displaying step, panning and zooming over the objects of interest are applied as the respective objects of interest are displayed on the display device along the path.

18. The method of claim 15 wherein one of the objects of interest is switched to a pre-defined object of interest.

19. The method of claim 15 wherein in the displaying step, panning and zooming along the path as a function of the properties of the objects of interest and the path.

20. The method of claim 15 wherein the objects of interests are assigned priorities as a function of the type of object of interest, the relative distances between the objects of interest, the distance between the objects of interest and the crop area, the color of the objects of interest, and the relative sizes of the objects of interest.

21. A method for displaying an image in a digital display device, comprising the steps of:
identifying one or more objects of interest in a source image, wherein each object of interest has one or more properties;
defining a crop area as a function of the one or more objects of interest, wherein the crop area is defined as a function of the properties of the objects of interest;
decoding the crop area into a canvas image;
defining a path for displaying one or more selected areas of the canvas image, wherein the path is defined as a function of the properties of the objects of interest;
panning and zooming along the path as a function of the properties of the objects of interest and the path; and
displaying the objects of interest on the display device along the path.

22. The method of claim 21 wherein the objects of interests are assigned priorities as a function of the type of object of interest, the relative distances between the objects of interest, the distance between the objects of interest and the crop area, the color of the objects of interest, and the relative sizes of the objects of interest; and wherein the path is defined as a function of the priorities of the objects of interest.
